(19) United States
(12) Patent Application Publication
(10) Pub. No.: US 2012/0237177 A1
(43) Pub. Date: Sep. 20, 2012

(54) LOCKING MECHANISM OF OPTICAL MODULE

(76) Inventor: YUUJI MINOTA, Tokyo (JP)

(21) Appl. No.: 13/368,547

(22) Filed: Feb. 8, 2012

(30) Foreign Application Priority Data
Mar. 17, 2011 (JP) 59499/2011

(51) Int. Cl. G02B 6/00

(52) U.S. Cl. 385/134

(57) ABSTRACT

A locking mechanism of an optical module, which is mounted on a communication apparatus, to lock the optical module includes a locking member which includes a locking pawl fitted into a locking ditch formed on the communication apparatus, and a rocking pin that is attached at a position between the guide part and the locking pawl; a locking lever which includes a lock releasing pawl that fits the guide part, and a finger stopping part that has a ring shape; and a handle which includes, a grip part that has a shape of a ring, wherein the handle is fixed on a base which is a main part of the optical module; and wherein the grip part has the ring shape which is larger adequately in size than the finger stopping part, and protects the finger stopping part,

This application is based upon and claims the benefit of priority from Japanese Patent Application No. 2011-059499, filed on Mar. 17, 2011, the disclosure of which is incorporated herein in its entirety by reference.

### TECHNICAL FIELD

The present invention relates to a locking mechanism of an optical module.

### BACKGROUND ART

In recent years, it is requested to make an optical communication apparatus miniaturized and to realize high density mounting on the optical communication apparatus.

In some case, an optical module, which is composed of an optical transceiver including a light emitting element and a light receiving element, is mounted on the optical communication apparatus so that the optical module may be removable.

Accordingly, to make the optical module, which includes a removing mechanism, miniaturized is one method to cope with the request for the miniaturization and the high density mounting.

In this case, if the optical module is removed due to careless touch or the like during communication, the communication is cut off and the apparatus is caused a breakdown.

Accordingly, a locking mechanism, which prevents the optical module from being removed carelessly, is proposed.

For example, Japanese Patent Application Laid-Open No. 2004-170594 discloses a locking mechanism of the optical module which includes a locking hole, a locking member and a lever. The locking hole is arranged at an insertion opening, into which the optical module is inserted, on a communication apparatus side. The locking member is mounted on the optical module. The lever moves the locking member so that a lock part, which is locked in the locking hole, may be removed from the locking hole.

When the lever is pulled, the lock part is rocked to be removed from the locking hole. As a result, the lock is released.

Moreover, when the lever is pulled furthermore in a state that the lock is released, the optical module is removed.

Accordingly, since the lock is not released if the lever is not pulled, it is possible to prevent a situation that the optical module is removed carelessly.

Moreover, Japanese Patent Application Laid-Open No. 2008-225134 discloses an optical transceiver which includes a grip, a latch member, an elastic body and a lever.

The grip is attached to a receptacle which slides in a direction of the optical transceiver being inserted and removed.

When the optical transceiver is put on a rail, an end part of the latch member is fitted into a fitting hole which is formed on the rail.

The elastic body energizes the latch member in a direction of the end part being fitted into the fitting hole.

The lever moves like a seesaw in cooperation with an operation of sliding the grip, and rotates the latch member against energizing force of the elastic body. Consequently, the above-mentioned fitting is released.

Accordingly, since the lock is not released if the operation of sliding the grip is not carried out, it is possible to prevent a situation that the optical module is removed carelessly.

Furthermore, Japanese Patent Application Laid-Open No. 2010-101944 discloses an optical module which includes a locking member, a lever and a locking mechanism.

The locking member is arranged so as to be able to be rocked and includes a locking projection for locking in a locking hole of a cage which stores a case.

The lever slides in parallel with a direction of removing the case.

The locking mechanism includes an energizing member which energizes the lever at a predetermined position.

As a result, the lock is released through pulling the lever. In the case that the lever is pulled furthermore in a state that the lock is released, the optical module can be removed. Therefore, it is possible to prevent a situation that the optical module is removed carelessly.

However, according to the configurations described in Japanese Patent Application Laid-Open No. 2004-170594 and Japanese Patent Application Laid-Open No. 2010-101944, the lever may be pulled due to careless touch or the like in some case, since the lock releasing means is in an exposed state.

On the other hand, according to the configuration described in Japanese Patent Application Laid-Open No. 2008-225134, it is rare to cause a trouble that the lever is caught due to the careless touch or the like. However, since the grip is a projection, which extends in the lateral direction, on the optical module which is long in the longitudinal direction, the grip operation and the pulling-out operations have to be carried out separately. As a result, a problem that the operation for pulling out the optical module becomes troublesome is caused.

In particular, in the case that many components such as the optical module or the like are mounted with high density, it is difficult to prepare space for the grip operation.

### SUMMARY

Accordingly, a main object of the present invention is to provide a locking mechanism of the optical module which has a feature that even if the careless touch is caused, it is difficult to release the lock, and it is easy to insert and remove the optical module with a simple operation.

A locking mechanism of an optical module, which is mounted on a communication apparatus, to lock the optical module including a locking member which includes a locking pawl that is formed on a front end position of the locking member and is fitted into a locking ditch formed on the communication apparatus, a guide part that is formed on a rear end position of the locking member, and a rocking pin that is attached at a position between the guide part and the locking pawl; a locking lever which includes a lock releasing pawl that is formed on a front end position of the locking lever and fits the guide part, and a finger stopping part that is formed on a rear end position of the locking lever and has a ring shape, wherein the locking lever is energized in the forward direction by a spring; and a handle which includes, a grip part that has a shape of a ring, wherein the handle is fixed on a base which is a main part of the optical module; and wherein the grip part has the ring shape which is larger adequately in size than the finger stopping part, and protects the finger stopping part.

The main effects of this invention are being hard to produce lock release by incorrect contact, and being able to exchange optical modules by easy operation.

### BRIEF DESCRIPTION OF THE DRAWINGS

Exemplary features and advantages of the present invention will become apparent from the following detailed description when taken with the accompanying drawings in which:

FIG. 1 is a perspective view of an upper surface of an optical module according to the present invention;

FIG. 2 is a perspective view of a lower surface, of the optical module;

FIG. 3 is an exploded perspective view of the optical module;

FIG. 4 is a perspective view of the. optical module whose spring storing part of the base stores a spring;

FIG. 5 is a perspective view of the optical module to whose base a handle and a locking lever are attached;

FIG. 6 is a perspective view of the optical module to whose base a locking member is attached;

FIG. 7 is a perspective view of the optical module to whose base a cover is attached;

FIG. 8A is a side view showing a state that the optical module is mounted on a communication apparatus;

FIG. 8B is a side view showing a state that the optical module is locked in the communication apparatus; and

FIG. 8C is a side view showing a state that the optical module is pulled out from the communication apparatus.

### EXEMPLARY EMBODIMENT

An exemplary embodiment of the present invention will be described.

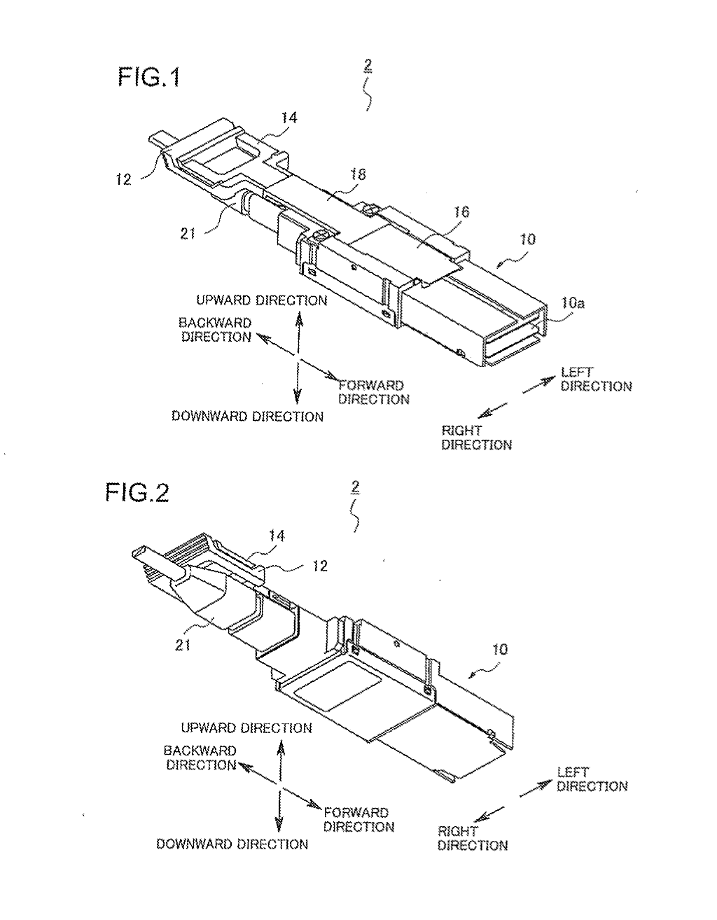

FIG. 1 is a perspective view of an upper surface of an optical module 2, and FIG. 2 is a perspective view of a lower surface of the optical module 2.

The optical module 2 includes a base 10 which stores an optical transceiver inside. A handle 12, a locking lever 14, a locking member 16, a cover 18 and the like are mounted on the base 10.

Here, according to FIG. 1 and FIG. 2, a cable connector 21 including an optical fiber and the like is attached.

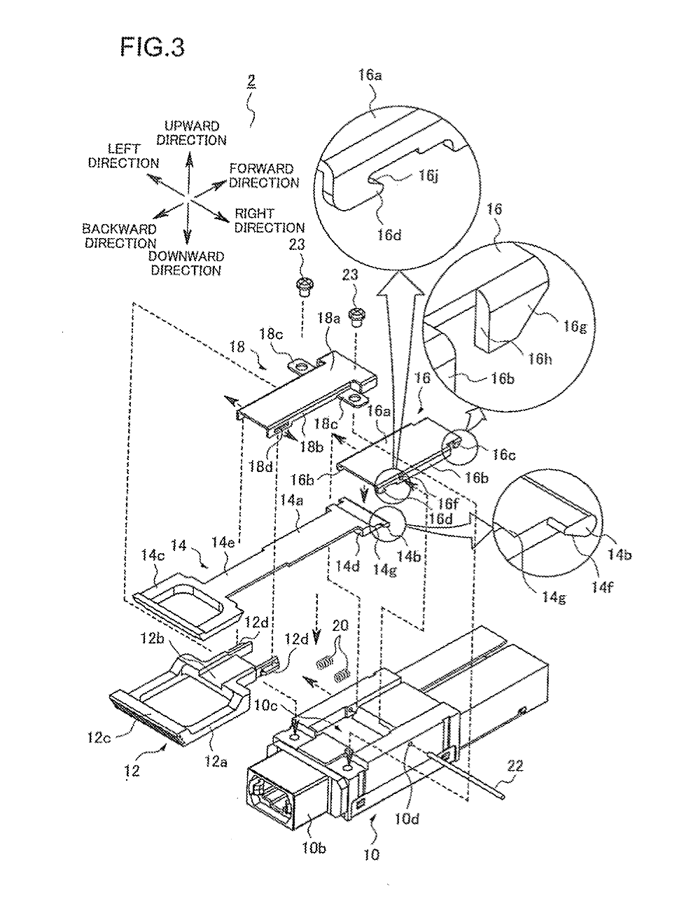

FIG. 3 is an exploded perspective view showing a procedure of assembling the optical module;

Terminology of a forward direction, a backward direction, an upward and downward direction and a right and left direction is used in the following description.

The terminology is defined in FIGS. 1 to 3.

Here, the forward direction may be described as an insertion direction or a direction toward an end, and the backward direction may be described as a pulling-out direction in some case.

While the communication apparatus into which the optical module is inserted and from which the optical module is removed is not shown in FIG. 1 to FIG. 3, the communication apparatus exists in the forward direction (insertion direction) of the optical module.

The base 10 has an external appearance of an almost cuboid shape. A terminal board 10a, which connects the communication apparatus and the optical module electrically, is arranged at a front end of the base 10 (refer to FIG. 1). A connector 10b, to which the cable connector 21 is attached, is arranged at a rear end of the base 10 (refer to FIG. 3).

Moreover, a spring storing part 10c, which stores a spring 20, is formed on an upper surface of the base 10, and a pin hole 10d, which penetrates the base 10 in the right and left direction, is formed op the upper surface.

A rocking pin 22 is inserted into the pin hole 10d.

The handle 12, which is a lever to be grasped when the optical module 2 is inserted into and removed from the communication apparatus, includes a ring type grip 12a, a slide part 12b, a stopping part 12c and a key 12d.

The stopping part 12c is formed in a rear end area of the grip part 12a, and the slide part 12b is formed in a front end area of the grip part 12a.

The grip part 12a is formed in a shape of a ring in order to make it possible to release the optical module from a locked state and to pull out the optical module through a user's inserting a finger inside the ring as mentioned later.

The slide part 12b is formed in a concave shape to work as a guide ditch when the locking lever 14 moves forward and backward.

Moreover, the key 12d, which has an almost cuboid shape, is protruded in the right and left direction in front of the slide part 12b.

The locking lever 14 includes a main part 14a, a guide part 14b which is arranged on a front end of the main part 14a, a finger stopping part 14c which is arranged on a rear side of the main part 14a, and a spring stopping part 14d.

Furthermore, the main part 14a includes a slider. 14e and a lock holding part 14g.

The guide part 14b, which is in a shape of a virtually triangular pole, is protruded in the width(right and left) direction from the main part 14a.

An upper surface of the guide part 14b crossing at a sharp angle is formed in parallel with a surface of the main part 14a (surface on which the locking lever 14 moves), and a lower surface of the guide part 14b inclines in the downward direction.

The inclined surface is denoted as a guide surface 14f.

The spring stopping part 14d is formed on a lower surface of the main part 14a and crosses approximately at right angles with the surface of the main part 14a.

The lock holding part 14g is a tapered surface which is formed at a position apart from the guide part 14b by a predetermined distance in the backward direction.

The locking member 16 includes a main part 16a, a side board 16b, a locking pawl 16c, a lock releasing pawl 16d, a guide touching part 16e and a rocking-pin hole 16f.

The side board 16b is arranged on a right side end and a left side end of the main part 16a of the locking member 16.

The rocking-pin hole 16f is formed so as to penetrate the side board 16b which is arranged at an intermediate position of the locking pawl 16c and the lock releasing pawl 16d.

The locking pawl 16c is formed on a front end of the side board 16b, and includes a receiving surface 16g and a locking surface 16h.

The receiving surface 16g inclines in the back direction toward the back.

Meanwhile, the locking surface 16h crosses approximately at right angles with the surface of the main part 16a.

The lock releasing pawl 16d is formed on a rear end of the side board 16b, and includes a slide surface 16j which crosses at a sharp angle with the surface of the main part 16a.

That is, the slide surface 16j is opposite to the guide surface 14f of the locking lever 14.

The cover 18, which includes a main part 18a, a side board 18b, a female screw board 18c for fixing the cover 18 on the main part 18a and a key fitting hole 18d, is fixed on the base 10 by a screw 23.

It is possible to make each member such as the locking lever 14, the locking member 16 or the like mentioned above in the resin molding process or by the sheet metal work.

In the case that there is a fear that the locking pawl 16c of the locking member 16 will be worn and damaged, it is preferable to make each member by the sheet metal work.

The sheet metal work has an advantage to be suitable for miniaturization of each member and to be able to suppress lack of strength that is caused when the member is miniaturized, etc.

Next, a procedure to assemble the optical module 2 mentioned above will be described.

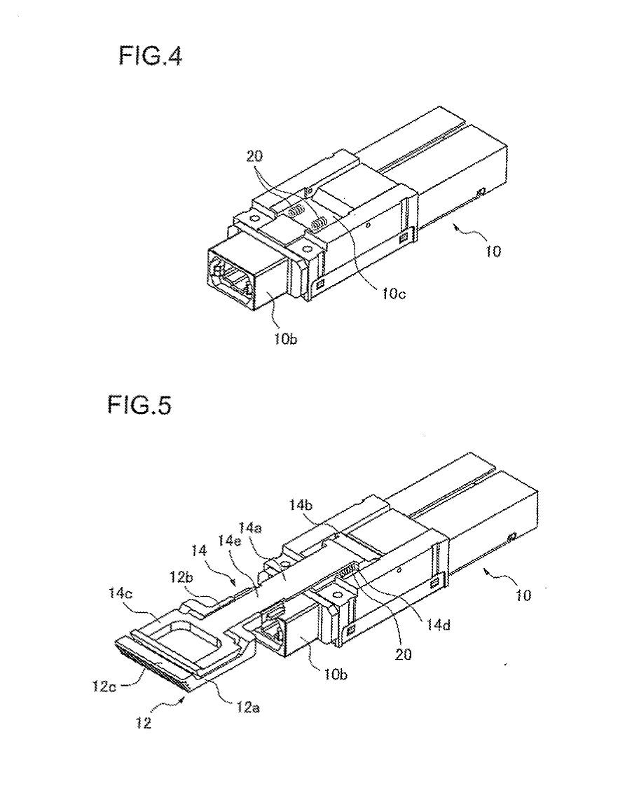

FIGS. 4 to 7 show the assembly procedure.

First, the spring 20 is inserted into the spring storing part 10c of the base 10 (refer to FIG. 4).

Afterward, while the slider 14e of the locking lever 14 is inserted into the slide part 12b of the handle 12, the handle 12 and the locking lever 14 are attached to the base 10.

At this time, while the spring 20 is pushed by the spring stopping part 14d of the locking lever 14 in the backward direction, the handle 12 and the locking lever 14 are attached to the base 10.

When the handle 12 and the locking lever 14 are attached to the base 10, the handle 12 exists outside the locking lever 14.

The stopping part 12c exists in a direction of the locking lever 14 moving at a time of releasing the lock.

Accordingly, the locking lever 14 is protected by the handle 12 even if a user touches the locking lever 14 carelessly. As a result, it is possible to prevent a situation that the optical module 2 is removed carelessly.

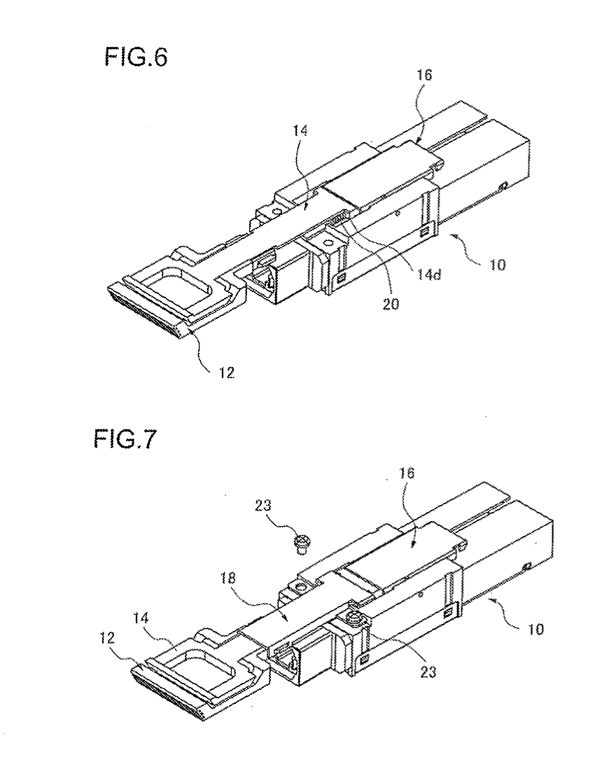

Next, the locking member 16 is attached (refer to FIG. 6).

When the locking member 16 is attached, the locking member 16 is inserted so that the lock releasing pawl 16d may wrap the guide part 14b of the locking lever 14.

At this time, since one end of the spring 20 touches the spring stopping part 14d of the locking lever 14 and energizes the locking lever 14 in the forward direction , the locking lever 14 tends to jump out from the spring storing part 10c in the forward direction.

Accordingly, the locking member 16 is put in while the locking lever 14 is pressed at the time of the assembly. After the locking member 16 is put in, the rocking pin 22 is inserted and supports the locking member 16 so that the locking member 16 may rock for the base 10.

After the locking member 16 is assembled, the locking lever 14 is fixed on the base 10 by the screw 23 while the locking lever 14 is pressed by the cover 18 (refer to FIG. 7).

When the cover 18 is attached, a key 18d is inserted into the key fitting hole 18d.

As a result, the handle 12 is fixed on the base 10 through the cover 18. Next, an operation, which is carried out when the optical module 2 assembled in this way is attached to. the communication apparatus, and removed from the communication apparatus, will be described.

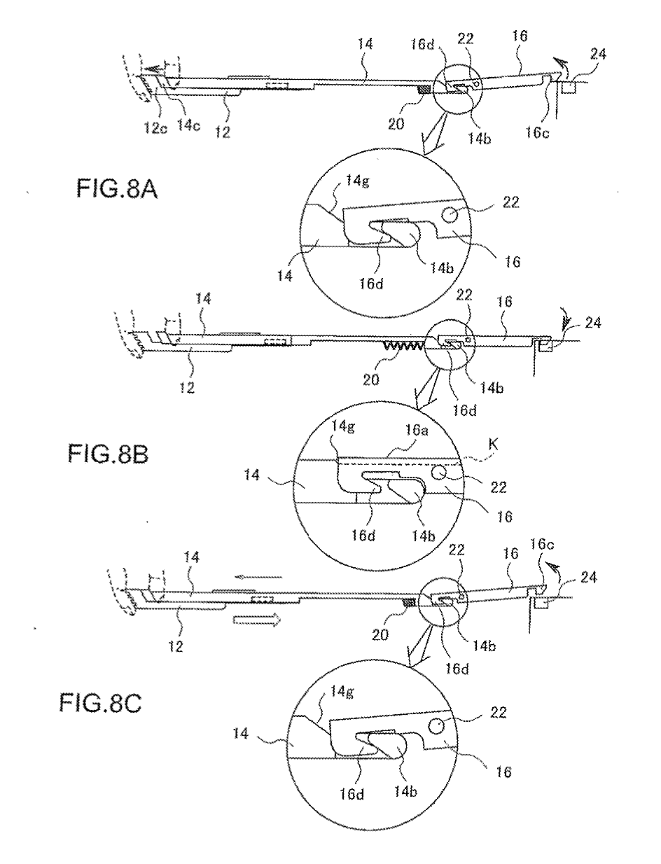

FIG. 8A is a side view of the optical module 2 at a time when the optical module 2 is inserted into the communication apparatus, and FIGS. 8B is a side view of the optical module 2 which is locked in the communication apparatus, and FIG. 8C is a side view of the optical module 2 at a time when the optical module 2 is removed from the communication apparatus.

Here, the base 10 or the like is omitted adequately in FIGS. 8A to 8C for the sake of understanding the operation with ease.

In the case that the optical module 2 is attached to the communication apparatus, the optical module 2 is inserted into a slot which is arranged on the communication apparatus.

At this time, the forefinger is inserted in the ring type finger stopping part 14c, and then the forefinger and the thumb catch the stopping part 12c of the handle 12 and the finger stopping part 14c of the locking lever 14.

Through catching the handle 12 and the locking lever 14, the locking lever 14 moves in the backward against force of the spring 20.

Afterward, the finger stopping part 14c touches the stopping part 12c, and then the locking lever 14 stops moving in the backward direction.

When the locking lever 14 moves in the backward direction, the guide part 14b of the locking lever 14 touches the lock releasing pawl 16d of the locking member 16.

When the locking lever 14 is moved in the backward direction furthermore, the guide part 14b is guided along the slide surface 16j of the lock releasing pawl 16d.

Since the slide surface 16j, works as a tapered surface for the guide surface 14f of the locking lever 14 which moves in the backward direction, the locking member 16 inclines in the counterclockwise direction shown in FIG. 8A around the rocking pin 22 which works as a rocking axis.

Accordingly, the locking pawl 16c, which is arranged on the front side of the locking member 16, moves in the upward direction, and consequently the locking pawl 16c leaves a locking ditch 24 of the communication apparatus (refer to FIG. 8A).

When the fingers release the handle 12 and the locking lever 14 in this state, the locking lever 14 moves in the forward direction by restoration force of the spring 20, and the locking pawl 16c is fitted into the locking ditch 24, and consequently the optical module 2 is locked (refer to FIG. 8B).

When the locking lever 14 is moved in the forward direction by the spring 20, the lock holding part 14g touches the main part 16a of the locking member 16.

A dotted line K in the enlarged diagram in FIG. 8B shows a lower surface of the main part 16a, and the lock holding part 14g touches an edge of the lower surface.

Accordingly, the locking member 16 cannot rock any more and the locked state is maintained.

Moreover, since the lock holding part 14g is the tapered surface, the lock holding part 14g touches the edge of the lower surface of the main part 16a smoothly and surely. As a result, it is possible to improve reliability on holding the locked state.

When releasing the locked state to pull out the optical module 2, the locking pawl 16c is moved in the upward direction through the forefinger and the thumb catching the stopping part 12c and the finger stopping part 14c (refer to FIG. 8C), similarly to the case of attaching the optical module 2.

As it has been described above, since the locking lever 14 is protected by the handle 12, it is possible to prevent the'situation that the optical module 2 is removed carelessly. Moreover, since it is possible to release the lock only through moving the locking lever 14 in the backward direction, it is possible to insert and remove the optical module with ease.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A locking mechanism of an optical module, which is mounted on a communication apparatus, to lock the optical module, comprising:
a locking member which includes
a locking pawl that is formed on a front end position of the locking member and is fitted into a locking ditch formed on the communication apparatus,
a guide part that is formed on a rear end position of the locking member, and
a rocking pin that is attached at a position between the guide part and the locking pawl;
a locking lever which includes
a lock releasing pawl that is formed on a front end position of the locking lever and fits the guide part, and
a finger stopping part that is formed on a rear end position of the locking lever and has a ring shape, wherein
the locking lever is energized in the forward direction by a spring; and
a handle which includes
a grip part that has a shape of a ring, wherein
the handle is fixed on a base which is a main part of the optical module; and wherein
the grip part has the ring shape which is larger adequately in size than the finger stopping part, and protects the finger stopping part.

2. The locking mechanism of the optical module according to claim 1, wherein
the guide part includes a virtually triangular pole projecting in a width direction from an end area of the locking lever, wherein
the triangular pole has one surface, which is parallel with a moving surface of the locking lever, and has a guide surface, which inclines a downward direction to the moving surface, and
the lock releasing pawl includes a slide surface opposite to the guide surface; wherein
the locking member rocks around the rocking pin to make the locking pawl left from the locking ditch when the slide surface being guided along the guide surface according to the locking lever, which is moved in the backward direction.

3. The locking mechanism of the optical module according to claim 1, wherein
the locking lever includes a lock holding part at a position apart from the guide part by a predetermined distance in the backward direction, and wherein
the lock holding part touches a rear end of the locking member to restrain the locking member from rocking when the locking lever is moved in the forward direction by force of the spring.

4. The locking mechanism of the optical module according to claim 3, wherein
the lock holding part is a tapered surface.

5. The locking mechanism of the optical module according to claim 1, wherein
the locking member is formed by the sheet metal work.

6. A locking mechanism of an optical module, which is mounted on a communication apparatus, to lock the optical module, comprising:
a locking member means which includes
a locking pawl means for forming on a front end position of the locking member means and fitting into a locking ditch formed on the communication apparatus,
a guide part means for forming on a rear end position of the locking member means, and
a rocking pin means for attaching at a position between the guide part means and the locking pawl means;
a locking lever means which includes
a lock releasing pawl means for forming on a front end position of the locking lever means and fits the guide part means, and
a finger stopping part means for forming on a rear end position of the locking lever means and has a ring shape, wherein the locking lever means is energized in the forward direction by a spring; and
a handle means which includes
a grip part means for having a shape of a ring, wherein the handle means is fixed on a base which is a main part means of the optical module; and wherein
the grip part means has the ring shape which is larger adequately in size than the finger stopping part means, and protects the finger stopping part means.

7. The locking mechanism of the optical module according to claim 6, wherein
the guide part means includes a virtually triangular pole projecting in a width direction from an end area of the locking lever means, wherein
the triangular pole has one surface, which is parallel with a moving surface of the locking lever means, and has a guide surface, which inclines a downward direction to the moving surface, and
the lock releasing pawl means includes a slide surface opposite to the guide surface; wherein
the locking member means rocks around the rocking pin means to make the locking pawl means left from the locking ditch when the slide surface being guided along the guide surface according to the locking lever means, which is moved in the backward direction.

8. The locking mechanism of the optical module according to claim 6, wherein
the locking lever means includes a lock holding part means at a position apart from the guide part means by a predetermined distance in the backward direction, and wherein
the lock holding part means touches a rear end of the locking member means to restrain the locking member means from rocking when the locking lever means is moved in the forward direction by force of the spring.

9. The locking mechanism of the optical module according to claim 8, wherein
the lock holding part means is a tapered surface.

10. The locking mechanism of the optical module according to claim 6, wherein
the locking member means is formed by the sheet metal work.
